(19) United States
(12) Patent Application Publication
(10) Pub. No.: US 2023/0421374 A1
(43) Pub. Date: Dec. 28, 2023

(54) CONCEPT FOR A TELEMETRY HUB FOR MICROSERVICES

(71) Applicant: Intel Corporation, Santa Clara, CA (US)

(72) Inventors: Rajesh POORNACHANDRAN, PORTLAND, OR (US); Kshitij A. DOSHI, Tempe, AZ (US); Rita H. WOUHAYBI, Portland, OR (US); Francesc GUIM BERNAT, Barcelona (ES); Karthik KUMAR, Chandler, AZ (US); Marcos CARRANZA, Portland, OR (US); Cesar MARTINEZ SPESSOT, Hillsboro, OR (US)

(21) Appl. No.: 17/809,297

(22) Filed: Jun. 28, 2022

(51) Int. Cl. H04L 9/30; H04L 9/32

(52) U.S. Cl. CPC H04L 9/30; H04L 9/3247

(57) ABSTRACT

Examples relate to a computer system, a telemetry hub apparatus, a telemetry hub device, a telemetry hub method, a microservice apparatus, a microservice device, a microservice method and to corresponding computer programs. The telemetry apparatus is configured to obtain telemetry information from a plurality of microservices, and to provide access to the telemetry information for the plurality of microservices according to an access scheme.

### FIELD

Examples relate to a computer system, a telemetry hub apparatus, a telemetry hub device, a telemetry hub method, a microservice apparatus, a microservice device, a microservice method and to corresponding computer programs.

### BACKGROUND

Today, meshes of services (and in particular microservices) are becoming one of the de factor standards to architect and implement applications or systems. For example, such applications may use third party building blocks (e.g., from CSPs, Cloud Service Providers) to implement some part of their pipelines.

In the context of microservices, different microservices that work together may benefit from sharing some amount of telemetry among each other. However, since the microservices originate from different sources, such telemetry sharing may be hindered by a lack of trust between the different microservices. Consequently, telemetry in microservices is often siloed given third-party involvement and concern around confidentiality/privacy due to lack of trust. This may result in less useful insights on performance, and in functional and interoperability issues due to lack of coherent end to end telemetry across the full pipeline, in particular in scenarios involving multi-party contributions in a cloud native domain.

### BRIEF DESCRIPTION OF THE FIGURES

Some examples of apparatuses and/or methods will be described in the following by way of example only, and with reference to the accompanying figures, in which

FIG. 1a shows a schematic diagram of an example of a telemetry hub apparatus or telemetry hub device;

FIG. 1b shows a schematic diagram of an example of a computer system comprising a telemetry hub apparatus or telemetry hub device and a plurality of microservices;

FIG. 1c shows a flow chart of an example of a telemetry hub method;

FIG. 2a shows a schematic diagram of an example of a microservice apparatus or microservice device;

FIG. 2b shows a flow chart of an example of a microservice method;

FIG. 3 shows a schematic diagram of an example of the proposed architecture; and

FIG. 4 shows a flow chart of a flow of the proposed concept.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

Various examples of the present disclosure relate generally to microservices, and in particular to a (homomorphic) telemetry systems.

The proposed concept relates to a concept for implementing different levels of telemetry sharing between microservices depending on the level of trust that they have vis-à-vis each other. In this context, telemetry can be platform hardware telemetry (e.g., network usage) or application KPIs (Key Performance Indicators e.g., TPS, Transactions Per Second). Microservices may want to share those telemetry metrics in different ways, depending on the microservice performing the access. The present disclosure relates to a concept for allowing this level of control and access to telemetry, including a concept for generating derived telemetry with the help of transformation functions.

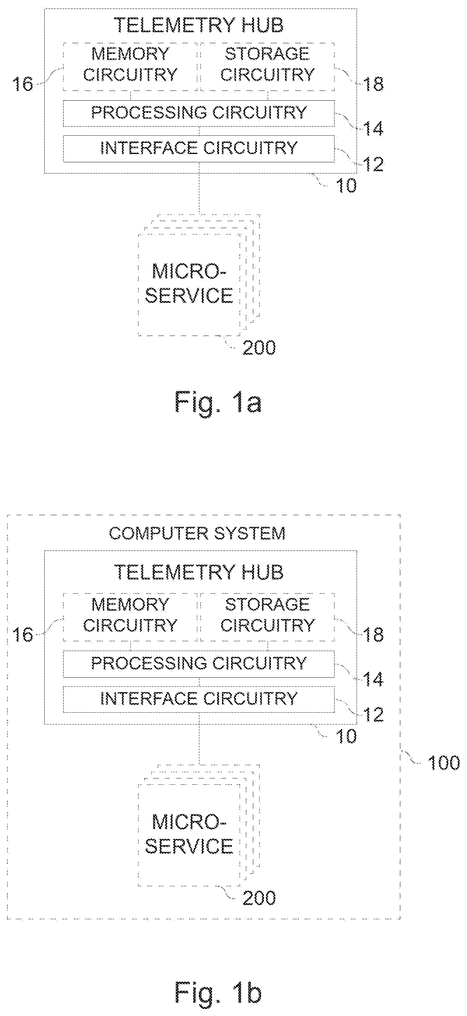

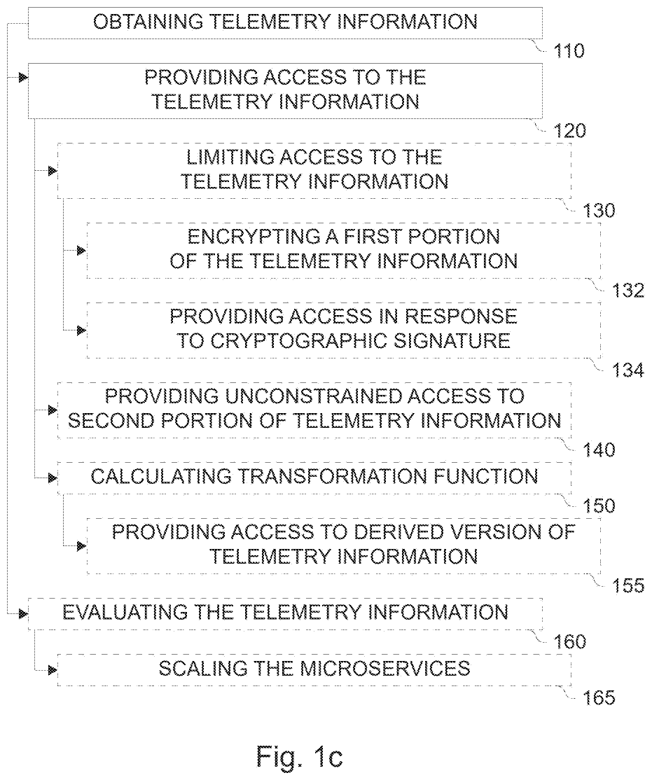

FIG. 1a shows a schematic diagram of an example of a telemetry hub apparatus 10 or telemetry hub telemetry hub device 10. The telemetry hub apparatus 10 comprises circuitry that is configured to provide the functionality of the telemetry hub apparatus 10. For example, the telemetry hub apparatus 10 of FIGS. 1a and 1b comprises (optional) interface circuitry 12, processing circuitry 14, memory circuitry 16 and (optional) storage circuitry 18. For example, the processing circuitry 14 may be coupled with the interface circuitry 12, with the memory circuitry 16 and with the storage circuitry 18. For example, the processing circuitry 14 may be configured to provide the functionality of the telemetry hub apparatus 10, in conjunction with the interface circuitry 12 (for exchanging information, e.g., with other components of the computer system or outside the computer system, such a plurality of microservices 200), the memory circuitry 16 (for temporarily storing information, such as machine-readable instructions) and the storage circuitry 18 (for permanently or semi-permanently storing information, such as the machine-readable instructions). Likewise, the telemetry hub device 10 may comprise means that is/are configured to provide the functionality of the telemetry hub device 10. The components of the telemetry hub device 10 are defined as component means, which may correspond to, or implemented by, the respective structural components of the telemetry hub apparatus 10. For example, the telemetry hub device 10 of FIGS. 1a and 1b comprises means for processing 14, which may correspond to or be implemented by the processing circuitry 14, (optional) means for communicating 12, which may correspond to or be implemented by the interface circuitry 12, memory 16, which may correspond to or be implemented by the memory circuitry 16 and (optional) means for storing information (i.e., storage) 18, which may correspond to or be implemented by the storage circuitry 18. In general, the functionality of the processing circuitry 14 or means for processing 14 may be implemented by the processing circuitry 14 or means for processing 14 executing machine-readable instructions. Accordingly, any feature ascribed to the processing circuitry 14 or means for processing 14 may be defined by one or more instructions of a plurality of machine-readable instructions. The telemetry hub apparatus 10 or telemetry hub device 10 may comprise the plurality of machine-readable instructions, e.g., within the memory circuitry 16 or memory 16 or within the storage circuitry 18 or means for storing information 18.

The processing circuitry 14 or means for processing 14 is configured to obtain telemetry information from a plurality of microservices 200. The processing circuitry 14 or means for processing 14 is configured to provide access to the telemetry information for the plurality of microservices according to an access scheme.

FIG. 1b shows a schematic diagram of an example of a computer system 100 comprising the telemetry hub apparatus 10 or telemetry hub device 100 and the plurality of microservices 200. In some examples, the microservices 200, or a subset of the microservices 200, may be hosted outside the computer system 100, e.g., by one or more other computer system.

FIG. 1c shows a flow chart of an example of a corresponding (computer-implemented) telemetry hub method. The method comprises obtaining 110 telemetry information from a plurality of microservices. The method comprises providing 120 access to the telemetry information for the plurality of microservices according to an access scheme.

In the following, the functionality of the telemetry hub apparatus 10, the telemetry hub device 10, the telemetry hub method and of a corresponding computer program is illustrated with respect to the telemetry hub apparatus 10. Features introduced in connection with the telemetry hub apparatus 10 may likewise be included in the corresponding telemetry hub device 10, telemetry hub method and computer program.

The proposed concept relates to a concept for exchanging telemetry information between microservices. It is based on the insight that, due to a lack of trust, the exchange of telemetry between microservices is often restricted. In the proposed concept, mechanisms are created that allow applications or services to provide hints or requirements to the software stack on how telemetry that is related to the specific service or application can be shared and handled at a system level.

In many cases, multiple microservices are working together to perform a specific use case (e.g., confidential computing). For instance, a first microservice M1 may perform video decoding and a second microservice M2 performing inferencing for a safety use cases. In order to be more effective, M2 may benefit from having access to certain telemetry generated by M1.

For instance, if M2 can gain access to the amount of CPU that M1 is consuming, it may be more effective in determining how much compute is needed or which type of compute is required (e.g., AVX2 (Advanced Vector Extensions 2) versus media acceleration etc.). However, depending on the level of trust between M1 and M2, M1 may only want to share certain types of telemetry or a transformation (e.g., a derived value) of such telemetry. For instance, it may prefer to provide access to a discrete telemetry that indicates a HIGH, MEDIUM or LOW amount of CPU load. However, a third microservice M3 that belongs to the same tenant as M1 may be provided with access to the precise amount of CPU that is used by M1.

Thus, telemetry for an application (hardware and application KPI/Telemetry) may be stored in a telemetry hub, which may give access to the stored telemetry information to the microservices.

In the proposed concept, the telemetry may be stored in a pooled system (e.g., a telemetry hub) and may be discoverable by other entities depending on certain properties. Various examples may use a combination of standard and homomorphic cryptography (or an emulation thereof) to create a more complex and flexible telemetry concept that allows controlling who can access the telemetry and what level of telemetry can be accessed. Moreover, the telemetry metrics may comprise different types of data sets: more generic derived data that can be accessed via homomorphic encryption and the full data sets for the metric that can be either accessible via the first and/or second approach.

In order to do that, the system telemetry architecture may be expanded in order to understand this notation of homomorphic telemetry systems. For example, telemetry stacks such as emon, collectd may be used to provide the interfaces that allow different services to express what telemetry metrics belong to a second, third or fourth type of providing access to the telemetry information—by default, metrics may be of a first type. The four types of telemetry sharing will be introduced in the following. Telemetry stacks may provide two types of interfaces, e.g., for providing access to the (raw) telemetry information, and for providing access to derived versions of the telemetry information.

First, the telemetry information is obtained (e.g., received) from the microservices. For example, the telemetry information may be stored in the telemetry hub apparatus, e.g., using the memory circuitry 16 or using the storage circuitry 18. For example, a publish-subscribe scheme or mechanism may be used for obtaining the telemetry information. For example, the processing circuitry may be configured to subscribe to the telemetry information published by the plurality of microservices. For example, the processing circuitry may be configured to provide an interface, such as an application programming interface, for submitting the telemetry information to the telemetry hub apparatus. This interface may be used by the microservices to provide (e.g., push) their respective telemetry information to the telemetry hub apparatus.

Once the telemetry information is obtained by the telemetry hub apparatus, it may be accessed by the plurality of microservices. In particular, the processing circuitry is configured to provide the access to the telemetry information for the plurality of microservices according to the access scheme. In this context, the access scheme may be a set of rules defining which microservice is allowed to access which telemetry information in which way. In other words, the access scheme may define, for the respective pieces (i.e., units) of telemetry information, at least one of one or more microservices (or one or more groups of microservices) being allowed access to the respective telemetry information and one or more levels of access provided to the telemetry information (e.g., access to the raw telemetry information or access to a derived version of the telemetry information). The access scheme may be defined by the respective microservice providing the telemetry information. For example, the processing circuitry may be configured to obtain information on the access scheme from the respective microservice providing the telemetry information. For example, the information on the access scheme may define, for the telemetry information provided by the respective microservice, at least one of one or more microservices being allowed access to the respective telemetry information and one or more levels of access provided to the telemetry information. In particular, the access scheme, and thus the information on the access scheme may define, for the respective piece/unit of telemetry information, a level of access provided to the telemetry information for a given microservice (or group of microservices). Consequently, the access scheme may define access to the telemetry information based on a per-microservice or per-group-of-microservices granularity. The access scheme may be used to restrict access to the telemetry information, e.g., to avoid any microservice gaining access to any of the telemetry information. In other words, the processing circuitry may be configured to limit access (e.g., to restrict access) to the telemetry information according to the access scheme. Accordingly, as further shown in FIG. 1c, the telemetry hub method may comprise 130 limiting access to the telemetry information according to the access scheme. For this purpose, one or more of the following four approaches may be used.

At least the first two approaches (or types of access) introduced below are based on restricting access to the telemetry information using cryptography, e.g., using public/private key cryptography. In the first approach, the telemetry may be stored and given access to only for the service (e.g., secured with public/private keys that only the service and the software stack know, e.g., with public/private keys that the microservice providing the respective telemetry information and one or more microservices forming a service architecture with the microservice providing the telemetry information know). In the second approach, the telemetry may be stored and given access to other peer services can access (e.g., secured with public/private keys that only the service, peer services and the software stack know, e.g., with public/private keys that the microservice providing the respective telemetry information, one or more microservices forming a service architecture with the microservice providing the telemetry information know and one or more trusted peer services/microservices know). For these purposes, at least the following implementations may be used—the telemetry information may be encrypted such, that they can only be decrypted by the microservice(s) being allowed to gain access to the telemetry information, or access to the telemetry information is conditional on the provision of a cryptographic signature that can only be generated by the microservice(s) being allowed to gain access to the telemetry information. For both approaches, the aforementioned public/private keys may be used.

For example, the processing circuitry may be configured to encrypt at least a first portion of the telemetry information with a per-microservice or per-group-of-microservices granularity. Accordingly, as further shown in FIG. 1c, the telemetry hub method may comprise encrypting 132 at least the first portion of the telemetry information with the per-microservice or per-group-of-microservices granularity. This may be achieved by encrypting at least the first portion of the telemetry information using a public key, with the corresponding private key only being known to the microservice(s) being allowed to gain access to at least the first portion of the telemetry information. In other words, the encryption may be based on a public key associated with the respective microservice or group of microservices (i.e., a public key being derived form a private key being held by the microservice(s) being allowed to gain access to the first portion of the telemetry information). Thus, the encryption may limit the access to the telemetry information based on the per-microservice or per-group-of-microservices granularity.

Alternatively, or additionally, the telemetry information might only be provided after a cryptography-based authentication performed by the microservice(s) being allowed to gain access to at least the first portion of the telemetry information. For example, the processing circuitry may be configured to provide access to at least the first portion of the telemetry information in response to a microservice-specific or group-of-microservices-specific cryptographic signature provided by the respective microservice. Accordingly, as further shown in FIG. 1c, the telemetry hub method may comprise providing 134 access to at least the first portion of the telemetry information in response to a microservice-specific or group-of-microservices-specific cryptographic signature provided by the respective microservice. For example, the processing circuitry may be configured to obtain a request for at least the first portion of the telemetry information. The request may comprise the cryptographic signature, which may be generated, based on the private key held by the respective microservice or group of microservices, by the microservice requesting access to at least the first portion of the telemetry information. The processing circuitry may then be configured to verify the cryptographic signature based on a public key associated with the respective microservice or group of microservices.

In a third approach, a combination of the first two approaches may be used, in combination with providing access to certain telemetry fields for anyone. For example, the processing circuitry may be configured to provide unconstrained access to a second portion of the telemetry information. Accordingly, as further shown in FIG. 1c, the telemetry hub method may comprise providing 140 unconstrained access to the second portion of the telemetry information. In this latter case, homomorphic encryption may be used to create this property. In other words, the processing circuitry may be configured to provide the unconstrained access to the second portion of the telemetry information by encrypting the second portion using homomorphic encryption. Alternatively, the telemetry hub apparatus may emulate the homomorphic encryption, by generating a derived version of the second portion of the telemetry information based on a transformation function. More details on this alternative will the provided in the following. Alternatively, the unconstrained access to the second portion of the telemetry information may provide access to the (raw) telemetry information (i.e., the telemetry information as obtained from the respective microservice(s)).

In a fourth approach, other peer services may access drive telemetry associated to that specific service. This approach may also be denoted microservice homomorphic telemetry. In the fourth approach, the concept behind homomorphic encryption may be emulated, by executing a (transformation) function over the raw telemetry when that telemetry metric is being accessed by/from a particular service with specific characteristics (e.g., belonging to tenant X). See also the example provided around telemetry being shared between M1 and M2, where the provision of telemetry information indicating a LOW, MEDIUM or HIGH processor load may be based on the use of a transformation function.

In various examples of the present disclosure, transformation functions are used to determine derived versions of the telemetry information. For example, the processing circuitry may be configured to calculate one or more transformation based on a third portion (and/or based on the second portion) of the telemetry information (i.e., to calculate a result of the one or more transformation functions based on the third portion of the telemetry information). The processing circuitry may be configured to provide access to a derived version of the third portion of the telemetry information by providing the result of the calculation. Accordingly, as further shown in FIG. 1c, the telemetry hub method may comprise calculating 150 the one or more transformation functions based on the third portion (and/or the second portion) of the telemetry information. The telemetry hub method may comprise providing 155 access to the derived version of the third portion of the telemetry information by providing the result of the calculation. This may be done to avoid the raw telemetry information being accessed by the microservice requesting the respective access.

In the following, two different types of transformation functions will be discussed—transformation functions (in the following denoted a first subset of the one or more transformation functions) that do not require or use a (numeric) input that is provided by the microservice accessing the respective telemetry information, and transformation functions (in the following denoted a second subset of the one or more transformation functions) that require a numeric input. In particular the latter (i.e., second) subset may be considered to emulate homomorphic cryptography, as they allow the determination of a result based on the telemetry information without disclosing the raw telemetry information. The former (i.e., first) subset, on the other hand, may be used to provide a layer of abstraction that obfuscates the telemetry information. Both types of transformation functions may be used to provide the aforementioned unconstrained access.

Turning now to the first subset of the one or more transformation functions. These transformation function(s) may serve the purpose of obfuscating the raw telemetry information (i.e., the telemetry information as provided by the respective microservice), such that the microservice gaining access do not gain access to the raw telemetry information. Accordingly, the transformation function may determine the derived version of the telemetry information by abstracting from the telemetry information (so that the derived version is less precise than the raw telemetry information). For example, this may include rounding a numeric value of the respective telemetry information, classifying the respective telemetry information (e.g., LOW, MEDIUM and HIGH), averaging a numeric value of the respective telemetry information (e.g., over multiple points in time or over multiple concurrent measurements), or determining a mean (e.g., over multiple points in time or over multiple concurrent measurements). Accordingly, at least the first subset of the one or more transformation functions may comprise at least one of a rounding component, a classification component, an averaging component, and a component for determining a mean.

The second subset may strive to emulate homomorphic encryption. In homomorphic encryption, the data (e.g., numeric values) is encrypted such, that they support some specific mathematical or Boolean calculations despite their encryption. For example, a pair of encrypted values may be added and compared to a third encrypted value (e.g., to determine whether the added values are larger or smaller than the third value), without gaining access to the respective unencrypted values. In the present disclosure, this approach may be emulated by the telemetry hub performing the calculations, based on a numeric input provided by the microservice requesting access to the telemetry information, by providing only the result of the transformation function to the requesting microservice. For example, the processing circuitry may be configured to calculate at least the second subset of the one or more transformation functions further based on a numeric input provided by (i.e., obtained from) a microservice requesting the result of the respective transformation function. Accordingly, as further shown in FIG. 1c, the telemetry hub method may comprise calculating 150 at least the second subset of the one or more transformation functions further based on the numeric input provided by the microservice requesting the result of the respective transformation function. To avoid exfiltration of the raw telemetry information, only a limited set of transformation functions might be allowed, or the number of requests per microservice may be limited. For example, at least the second subset of the one or more transformation functions may comprise at least one of a comparison component (for comparing the numeric input to one or more numeric values contained in the telemetry information) and a Boolean algebra component (e.g., for combining multiple comparisons). Additionally, different types of transformation functions may be supported. For example, the at least the second subset of the one or more transformation functions may (additionally) comprise at least one of an addition component, a subtraction component, a multiplication component, and a division component. These component vastly extend the capabilities of these types of transformation functions, but care may be needed in the design to avoid exfiltrating the raw telemetry information.

In some examples, the transformation function(s) may be defined separately for each microservice or group of microservices requesting access to the telemetry information. The microservice providing the respective telemetry information may specify separately, for each microservice or group of microservices, the transformation function to use for generating the respective derived version of the telemetry information. Accordingly, the processing circuitry may be configured to calculate microservice-specific transformation functions or group-of-microservices-specific transformation functions based on the third portion of the telemetry information (as defined by the microservice providing the respective telemetry information). Accordingly, the telemetry hub method may comprise calculating 150 micro-service-specific transformation functions or group-of-microservices-specific transformation functions based on the third portion of the telemetry information. Moreover, the transformation function(s) may be defined separately for each piece or unit (in the following also denoted set) of telemetry information being made accessible via such a transformation function. For example, the third portion (and/or the second portion) of the telemetry information may comprise a plurality of sets of telemetry data. The processing circuitry may be configured to calculate a plurality of set-of-telemetry-data-specific transformation functions based on the third portion (and/or the second portion) of the telemetry information. Accordingly, the telemetry hub method may comprise calculating 150 the plurality of set-of-telemetry-data-specific transformation functions based on the third portion (and/or the second portion) of the telemetry information.

In various examples of the present disclosure, the transformation function(s) may be predefined by the telemetry hub apparatus, with the microservices providing the respective telemetry information selecting one of the pre-defined transformation function(s) by defining the access scheme. Alternatively, the microservice(s) providing the respective telemetry information may specify the transformation functions, e.g., as code to be executed by the processing circuitry/telemetry hub apparatus.

In various examples, the four different approaches may be combined. For example, the access to the derived version of the telemetry information may be further limited using cryptography.

Telemetry processing may involve clustering and cross correlation techniques to align the telemetry based on functionality, time series, resource series, etc., towards effective root-cause analysis for both hardware and software failures with quick turn-around time to improve microservice scalability. Based on the aforementioned four approaches (but not limiting to these four approaches), microservice choice of XPU (X Processing Unit, where X stands for an arbitrary type of accelerator) hardware, co-existing neighbors/tenants, may be determined towards an efficient placement strategy.

In the previous examples, the terms first portion, second portion and third portion were used. This subdivision of the telemetry information is based on the access scheme, where the microservice(s) providing the telemetry information define how the telemetry information should be accessed. Depending on the access scheme being selected by the respective microservice, the telemetry information provided by the microservice may fall within the three portions. The first, second and third portion may thus be defined by the access scheme, and thus by the microservices providing the respective telemetry information.

The proposed concept may provide an improved concept for articulating telemetry access policies for distributed systems and a novel way of share telemetry information in scale-out (e.g., service meshes). Various examples of the present disclosure may relate to one or more of a telemetry definition that considers different access and transformation policies for microservice-based systems, methods to configure and setup telemetry architecture, methods to retrieve the telemetry in the defined modes, methods to configure and execute new telemetry type on the platform and methods to gain access to telemetry in a distributed fashion using the proposed type of access rules (i.e., access scheme).

In some examples, the telemetry hub apparatus might not only be used for providing access to the telemetry information for the microservices. Additionally, the telemetry hub apparatus may use the telemetry information to orchestrate the microservices, e.g., to scale up or down the microservices. For example, the processing circuitry may be configured to evaluate the telemetry information based on a set of rules on a scaling of the plurality of microservices, and to scale up or scale down the plurality of microservices based on the evaluation. Accordingly, as further shown in FIG. 1c, the telemetry hub method may comprise evaluating 160 the telemetry information based on a set of rules on a scaling of the plurality of microservices and scaling 165 up or scaling down the plurality of microservices based on the evaluation. For example, the set of rules may define threshold value(s) (for both hardware load and application-specific key performance indicators) for scaling the plurality microservices up or down. For example, if the telemetry information indicates that a microservice processes more than a pre-defined threshold number of requests per unit of time, or that the processor load or memory load of the microservice exceeds a threshold value, another microservice of the same type may be spawned, or the microservice may be supplied with a higher amount of memory or additional processor resources. Similarly, if the telemetry information indicates that a microservice processes less than a second pre-defined threshold number of requests per unit of time, or that the processor load or memory load of the microservice falls below a second threshold value, the microservice may be supplied with a lower amount of memory or fewer processor resources, or the microservice may be shut down, with the work being taken over by a microservice of the same type.

In general, a microservice is a (self-contained) software application that is executed in a runtime environment, e.g., a runtime environment within a software container, a runtime environment within a virtual machine or a runtime environment provided in user space. Microservices are denoted microservices, as they generally provide only a limited portion of functionality of a combination (a so-called mesh) of microservices. Together, the mesh of microservices provide a service. To give an example, a first microservice may provide a database service, a second microservice may process input data, a third microservice may store the processed input data provided by the second microservice in a database provided by the first microservice. A fourth microservice may provide a user interface for accessing the processed input data, by retrieving the processed input data from the database provided by the first microservice. All of the microservices may be executed in separate containers, virtual machines and/or on different hosts. Moreover, all of the microservices may be spawned multiple times, to perform load balancing and/or to make the mesh of microservices more resilient.

The proposed concept may support arbitrary types of telemetry information. For example, the telemetry information may comprise information on one or more of a load of the respective microservice (e.g., a hardware load or a software load (concurrent number of requests etc.)), a rate of hardware utilization by the respective microservice, a rate of central processing unit (CPU) utilization by the respective microservice, a rate of graphics processing unit (GPU) utilization by the respective microservice, a rate of accelerator hardware utilization (e.g., of an FPGA, a machine-learning accelerator, offloading circuitry etc.) by the respective microservice, a rate of memory utilization by the respective microservice, a rate of network utilization by the respective microservice, a throughput of the microservice, a cache depth of the respective microservice and a latency of using the respective microservice. Some of the telemetry information may be hardware-related (e.g., the rate of hardware/CPU/GPU/accelerator hardware/memory utilization), while some telemetry information may relate to the performance of the software microservice (e.g., the throughput, the cache depth, or the latency of using the respective microservice). For example, technologies like Intel® Performance Counter Monitor (PCM) or Performance Monitoring Unit (PMU) may be used to determine at least some of the telemetry information.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general-purpose processor, a Digital Signal Processor (DSP), a micro-controller, etc.

For example, the memory circuitry 16 or memory 16 may comprise volatile or non-volatile memory, e.g., circuitry for providing volatile or non-volatile memory. For example, the memory circuitry or memory 16 may be random-access memory (RAM), such as dynamic random-access memory (DRAM) or static random-access memory (SRAM), or persistent memory (PMEM). For example, at least a portion of the memory circuitry may be part of the processing circuitry, e.g., registers of the processing circuitry.

For example, the storage circuitry 18 or means for storing information 18 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the computer system 100 may be a workstation computer system (e.g., a workstation computer system being used for scientific computation).

In general, the telemetry hub apparatus may be a hardware apparatus that is part of the computer system 100. For example, the telemetry hub apparatus may be a controller of the computer system that either uses the CPU of the computer system or that comprises a separate microcontroller (i.e., processing circuitry) for providing the functionality of the telemetry hub apparatus. For example, the telemetry hub apparatus may be implemented as part of a system configuration controller (also denoted Ubox).

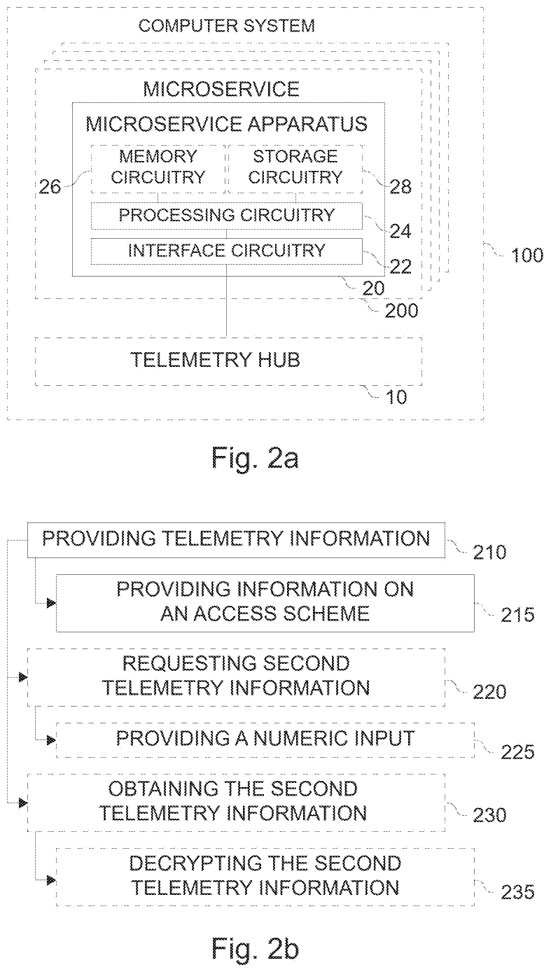

More details and aspects of the telemetry hub apparatus 10, telemetry hub device 10, telemetry hub method, computer program and computer system 100 are mentioned in connection with the proposed concept or one or more examples described above or below (e.g., FIGS. 2 to 4). The telemetry hub apparatus 10, telemetry hub device 10, telemetry hub method, computer program and computer system 100 may comprise one or more additional optional features corresponding to one or more aspects of the proposed concept, or one or more examples described above or below.

FIG. 2a shows a schematic diagram of an example of a microservice apparatus 20 or microservice device 20. The microservice apparatus 20 comprises circuitry that is configured to provide the functionality of the microservice apparatus 20. For example, the microservice apparatus 20 of FIGS. 2a and 2b comprises (optional) interface circuitry 22, processing circuitry 24, memory circuitry 26 and (optional) storage circuitry 28. For example, the processing circuitry 24 may be coupled with the interface circuitry 22, with the memory circuitry 26 and with the storage circuitry 28. For example, the processing circuitry 24 may be configured to provide the functionality of the microservice apparatus 20, in conjunction with the interface circuitry 22 (for exchanging information, e.g., with other components of the computer system or outside the computer system, such as a telemetry hub 10), the memory circuitry 26 (for temporarily storing information, such as machine-readable instructions) and the storage circuitry 28 (for permanently or semi-permanently storing information, such as the machine-readable instructions). Likewise, the microservice device 20 may comprise means that is/are configured to provide the functionality of the microservice device 20. The components of the microservice device 20 are defined as component means, which may correspond to, or implemented by, the respective structural components of the microservice apparatus 20. For example, the microservice device 20 of FIG. 2a comprises means for processing 24, which may correspond to or be implemented by the processing circuitry 24, (optional) means for communicating 22, which may correspond to or be implemented by the interface circuitry 22, memory 26, which may correspond to or be implemented by the memory circuitry 26 and (optional) means for storing information (i.e., storage) 28, which may correspond to or be implemented by the storage circuitry 28. In general, the functionality of the processing circuitry 24 or means for processing 24 may be implemented by the processing circuitry 24 or means for processing 24 executing machine-readable instructions.

Accordingly, any feature ascribed to the processing circuitry 24 or means for processing 24 may be defined by one or more instructions of a plurality of machine-readable instructions. The microservice apparatus 20 or microservice device 20 may comprise the plurality of machine-readable instructions, e.g., within the memory circuitry 26 or memory 26 or within the storage circuitry 28 or means for storing information 28.

The processing circuitry 24 or means for processing 24 is configured to provide telemetry information of a first microservice associated with the microservice apparatus to the telemetry hub 10 (e.g., via the interface circuitry 22 or means for communicating 22). The processing circuitry 24 or means for processing 24 is configured to provide information on an access scheme for gaining access to the telemetry information of the first microservice to the telemetry hub 10 (e.g., via the interface circuitry 22 or means for communicating 22).

FIG. 2a further shows a computer system comprising the telemetry hub 10 and one or more microservice apparatuses 20 or microservice devices 20, as part of one or more microservices 200. For example, the microservice apparatus 20 or microservice device 20 may implement a portion of the functionality of the microservice 200 being associated with the microservice device 20, e.g., the portion of the functionality related to the provision and access of telemetry information involving the telemetry hub 10.

FIG. 2b shows a flow chart of an example of a corresponding (computer-implemented) microservice method. The method comprises providing 210 the telemetry information of the first microservice performing the microservice method to a telemetry hub. The method comprises providing 215 the information on an access scheme for gaining access to the telemetry information of the first microservice to the telemetry hub.

In the following, the functionality of the microservice apparatus 20, the microservice device 20, the microservice method and of a corresponding computer program is illustrated with respect to the microservice apparatus 20. Features introduced in connection with the microservice apparatus 20 may likewise be included in the corresponding microservice device 20, microservice method and computer program.

In connection with FIGS. 1a to 1c, the functionality of the telemetry hub (apparatus or device) 10 was discussed. This telemetry hub is both provided with the telemetry information from microservices and being used to access telemetry information of other microservices. This functionality, i.e., the provision of the telemetry information, and accessing the telemetry information of other microservices, is performed by the proposed microservice apparatus 20, microservice device 20, microservice method and corresponding computer program.

The microservice apparatus 20 is configured to provide the telemetry information of the first microservice associated with the microservice apparatus to the telemetry hub 10. For example, the processing circuitry may be configured to obtain the telemetry information from the first microservice, e.g., by evaluating system statistics of a container, virtual machine or runtime environment being used to provide the microservice, and/or by accessing the telemetry information via an API of the microservice. For example, the processing circuitry may be configured to periodically or aperiodically (e.g., event-driven) collect updated telemetry information from the first microservice, and to provide the updated telemetry information to the telemetry hub.

Along with the telemetry information, the microservice apparatus 20 further provides the information on the access scheme for gaining access to the telemetry information of the first microservice to the telemetry hub. The information on the access scheme has been discussed in connection with the telemetry hub. It may be supplied by an administrator or creator of the first microservice, to define which other microservices are provided with which level of access to the telemetry information. For example, the information on the access scheme may be provided with the first

In addition to providing the telemetry information for use by other microservices, some microservices also benefit from accessing telemetry information of the other microservices. Thus, the microservice apparatus may also be used to access such telemetry information via the telemetry hub. For example, the processing circuitry may be configured to obtain second telemetry information of a second microservice (e.g., of one or more second microservices) from the telemetry hub. Accordingly, as further shown in FIG. 2b, the microservice method may comprise obtaining 230 the second telemetry information of the second microservice from the telemetry hub. For example, a publish-subscribe scheme may be used, wherein the second telemetry information is published by the telemetry hub and the microservice apparatus subscribes to the second telemetry information. Alternatively, or to setup the publish-subscribe scheme, the second telemetry information may be requested from the telemetry hub by the microservice apparatus. For example, the processing circuitry may be configured to request the second telemetry information from the telemetry hub (e.g., via the interface circuitry 22). Accordingly, as further shown in FIG. 2b, the microservice method may comprise requesting 220 the second telemetry information from the telemetry hub. The second microservice information may then be obtained from the telemetry hub in response to the request. For example, the processing circuitry may be configured to request updates to the second telemetry information periodically or aperiodically (e.g., event-driven), e.g., according to a pre-defined update schedule or as needed/requested by the first microservice. The processing circuitry may be configured to provide the obtained second microservice information to the first microservice.

As outlined in connection with FIGS. 1a to 1b, access to the second telemetry information may be restricted by the access scheme defined by the microservices/microservice apparatuses providing the second telemetry information. For example, this access restriction may be implemented using encryption. Consequently, the microservice apparatus may decrypt the second telemetry information (if it is encrypted as part of the relevant access scheme), or to provide a cryptographic signature to the telemetry hub as part of the request for the second telemetry information. In other words, the processing circuitry may be configured to decrypt the second telemetry information based on a microservice-specific cryptographic key or based on a group-of-microservices-specific cryptographic key (e.g., using the microservice-specific or group-of-microservices-specific private key from which the public key being used to encrypt the second telemetry information is derived). Accordingly, as further shown in FIG. 2b, the microservice method may comprise decrypting 235 the second telemetry information based on a microservice-specific cryptographic key or based on a group-of-microservices-specific cryptographic key. Alternatively (or additionally), the processing circuitry may be configured to include the cryptographic signature in the request for the second telemetry information. In other words, the request may comprise a cryptographic signature being based on microservice-specific cryptographic key or based on a group-of-microservices-specific cryptographic key (e.g., using the microservice-specific or group-of-microservices-specific private key from which the public key being used to verify the cryptographic signature is derived. For example, the telemetry hub may generate the cryptographic signature based on a random bit string or based on a challenge bit string provided by the telemetry hub.

In some of the approaches for accessing the telemetry information introduced in connection with FIGS. 1a to 1c, transformation functions are used to calculate derived versions of the telemetry information, which are then provided in lieu of the telemetry information. Accordingly, the second telemetry information may comprise derived telemetry information that is calculated based on a transformation function. While some transformation functions do not require or take inputs provided by the microservice requesting the telemetry information, some transformation functions use such numeric inputs. Thus, the processing circuitry may be configured to provide a numeric input to the transformation function to the telemetry hub (e.g., as part of the request). Accordingly, the microservice method may comprise providing 225 a numeric input to the transformation function to the telemetry hub. For example, the numeric information may be provided by the first microservice (and may depend on telemetry of the first microservice or depend on a specific information need of the first microservice, or it may be hard coded into the request (if the numeric input does not change).

The interface circuitry 22 or means for communicating 22 may correspond to one or more inputs and/or outputs for receiving and/or transmitting information, which may be in digital (bit) values according to a specified code, within a module, between modules or between modules of different entities. For example, the interface circuitry 22 or means for communicating may comprise circuitry configured to receive and/or transmit information.

For example, the processing circuitry 24 or means for processing 24 may be implemented using one or more processing units, one or more processing devices, any means for processing, such as a processor, a computer or a programmable hardware component being operable with accordingly adapted software. In other words, the described function of the processing circuitry 24 or means for processing may as well be implemented in software, which is then executed on one or more programmable hardware components. Such hardware components may comprise a general-purpose processor, a Digital Signal Processor (DSP), a micro-controller, etc.

For example, the memory circuitry 26 or memory 26 may comprise volatile or non-volatile memory, e.g., circuitry for providing volatile or non-volatile memory. For example, the memory circuitry or memory 26 may be random-access memory (RAM), such as dynamic random-access memory (DRAM) or static random-access memory (SRAM), or persistent memory (PMEM). For example, at least a portion of the memory circuitry may be part of the processing circuitry, e.g., registers of the processing circuitry.

For example, the storage circuitry 28 or means for storing information 28 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the microservice apparatus 20, microservice device 20, microservice method, computer program and computer system 100 are mentioned in connection with the proposed concept or one or more examples described above or below (e.g., FIGS. 1a to 1c, 3 to 4). The microservice apparatus 20, microservice device 20, microservice method, computer program and computer system 100 may comprise one or more additional optional features corresponding to one or more aspects of the proposed concept, or one or more examples described above or below.

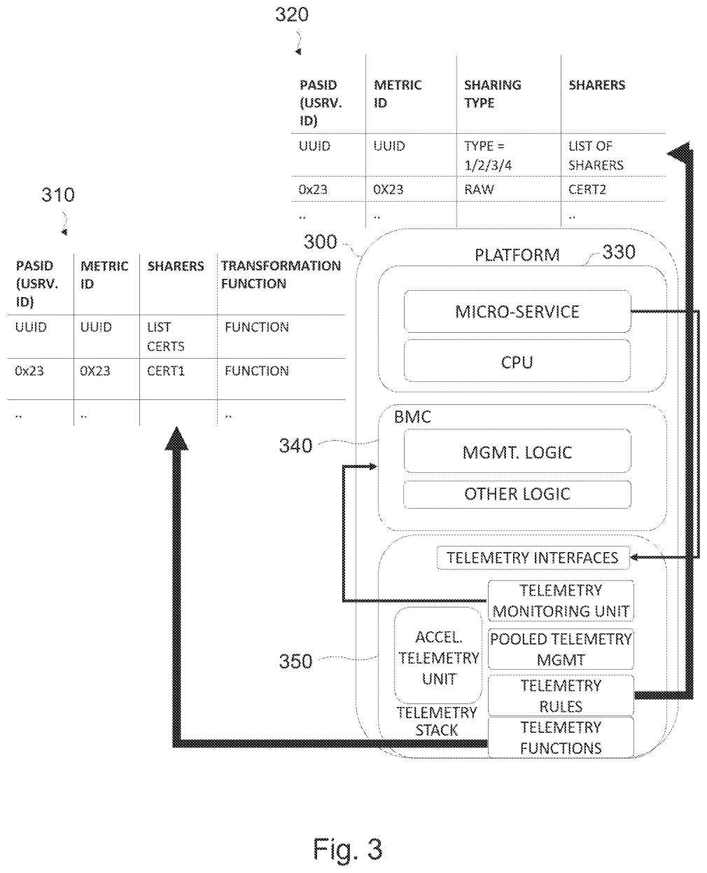

FIG. 3 shows a schematic diagram of an example of the proposed architecture. FIG. 3 shows a computer system 300 (which may be implemented similar to the computer system 100 of FIGS. 1a, 1b and/or 2a) comprising a platform 330 with a CPU (Central Processing Unit, e.g., the processing circuitry 14) and a microservice, a BMC (Baseboard Management Controller) 340 with management logic and other logic, and a telemetry stack 350 (e.g., the telemetry hub apparatus/device 10), comprising an acceleration telemetry unit, telemetry interfaces, a telemetry monitoring unit, pooled telemetry management, telemetry rules and telemetry functions. FIG. 3 further shows telemetry functions 310 (a table with columns PASID (Process Address ID), Metric ID, sharers, and transformation function) and telemetry rules 320 (with columns PASID, Metric ID, sharing type and sharers). For example, the telemetry rules 320 may define the access scheme for accessing the telemetry information, while the telemetry functions 310 may defined the one or more transformation functions.

The proposed architecture may comprise a combination of software and hardware schemes that allow to perform the previously described flows. The software platform may be expanded with new software building blocks (in the telemetry stack, highlighted with double borders) that allow the microservices to setup and access to the new scheme. On the one hand, a set of interfaces may be provided that allows to set up the telemetry rules 320. A microservice (that is represented by a process address ID—PASID) may configure two methods. It can register a telemetry homomorphic transformation function for a particular telemetry metric (in the telemetry functions 310). This transformation function may be implemented in multiple forms (P4, bits-streams etc.) and may be executed in a (new) platform acceleration unit (e.g., the telemetry hub). The microservice may further setup the access properties for a particular platform or system telemetry mapped into the PASID (via the telemetry rules 320). These access properties may include type of telemetry access type (e.g., the access scheme) for a list of different sharers. Sharers (i.e., microservices providing telemetry information) may be identified by a set of UUID (Universally Unique Identifier), certificates or PASIDs. The registration may include a function ID as well in case of sharing type 4. The sharing types are the same as shown in connection with FIGS. 1a to 1c.

The software platform may be expanded as well with a set of building blocks (telemetry monitoring unit, telemetry rules etc.) that are responsible for implementing the telemetry architecture described. These building blocks may (1) gather the telemetry configured per each of the microservices, (2) store the telemetry metric into the local memory or memory pool and/or (3) provide the access to the different microservices to telemetry using the right type of access (e.g., based on the access scheme). The software stack may provide means to the microservices to register and/or authenticate themselves. This authentication may be used by the software to be sure that the right level of access and transformations are provided. The access to telemetry may imply that some of those building blocks may be instantiated in pooled storage or pooled telemetry appliance.

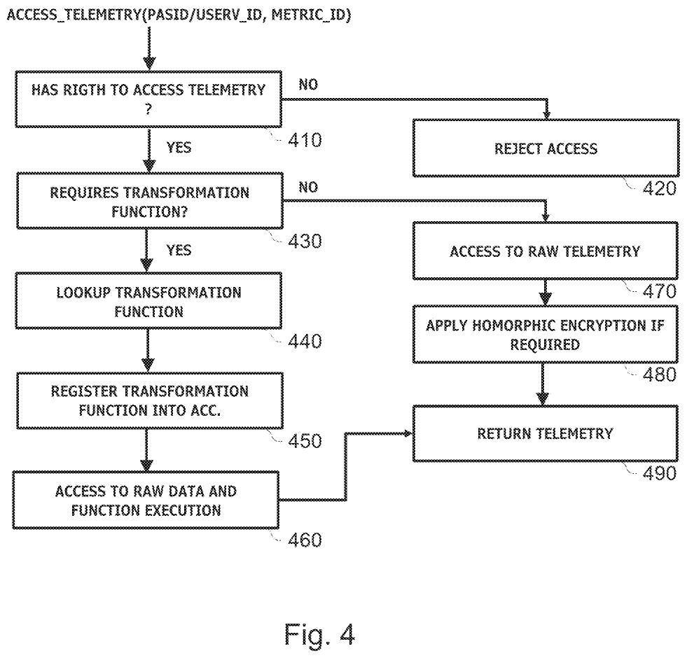

FIG. 4 shows a flow chart of a flow of the proposed concept, where a microservice may attempt to gain access to telemetry, using a function ACCESS_TELEMETRY with parameters PASID/USERV_ID and Metric_ID (indicating the telemetry being accessed). The flow comprises determining 410 whether the microservice has the right to access the telemetry. If not, access to the telemetry may be rejected 420. If yes, the flow comprises determining 43—whether a transformation function is required. If a transformation function is required, the transformation function is looked up 440, and the transformation function is registered into the acc. 450, the function is executed 460 based on the raw data and the telemetry is returned 490. If no transformation function is required, the raw telemetry is accessed 470, homomorphic encryption may be applied if required 480, and the telemetry is returned 490.

More details and aspects of the concept for accessing telemetry are mentioned in connection with the proposed concept or one or more examples described above or below (e.g., FIG. 1a to 2b). The concept for accessing telemetry may comprise one or more additional optional features corresponding to one or more aspects of the proposed concept, or one or more examples described above or below.

In the following, some examples of the proposed concept are presented:

An example (e.g., example 1) relates to a telemetry hub apparatus (10) comprising interface circuitry (12), machine-readable instructions and processing circuitry (14) to execute the machine-readable instructions to obtain telemetry information from a plurality of microservices (200), and to provide access to the telemetry information for the plurality of microservices according to an access scheme.

Another example (e.g., example 2) relates to a previously described example (e.g., example 1) or to any of the examples described herein, further comprising that the plurality of machine-readable instructions comprise instructions for limiting access to the telemetry information according to the access scheme, with the access scheme being defined by the respective microservice providing the telemetry information.

Another example (e.g., example 3) relates to a previously described example (e.g., one of the examples 1 to 2) or to any of the examples described herein, further comprising that the access scheme defines access to the telemetry information based on a per-microservice or per-group-of-microservices granularity.

Another example (e.g., example 4) relates to a previously described example (e.g., example 3) or to any of the examples described herein, further comprising that the plurality of machine-readable instructions comprise instructions for encrypting at least a first portion of the telemetry information with a per-microservice or per-group-of-microservices granularity, with the encryption limiting the access to the telemetry information based on the per-microservice or per-group-of-microservices granularity.

Another example (e.g., example 5) relates to a previously described example (e.g., example 4) or to any of the examples described herein, further comprising that the encryption is based on a public key associated with the respective microservice or group of microservices.

Another example (e.g., example 6) relates to a previously described example (e.g., example 3) or to any of the examples described herein, further comprising that the plurality of machine-readable instructions comprise instructions for providing access to at least the first portion of the telemetry information in response to a microservice-specific or group-of-microservices-specific cryptographic signature provided by the respective microservice.

Another example (e.g., example 7) relates to a previously described example (e.g., example 6) or to any of the examples described herein, further comprising that the plurality of machine-readable instructions comprise instructions for verifying the cryptographic signature based on a public key associated with the respective microservice or group of microservices

Another example (e.g., example 8) relates to a previously described example (e.g., one of the examples 6 to 7) or to any of the examples described herein, further comprising that the plurality of machine-readable instructions comprise instructions for providing unconstrained access to a second portion of the telemetry information.

Another example (e.g., example 9) relates to a previously described example (e.g., one of the examples 1 to 8) or to any of the examples described herein, further comprising that the plurality of machine-readable instructions comprise instructions for calculating one or more transformation functions based on a third portion of the telemetry information, and instructions for providing access to a derived version of the third portion of the telemetry information by providing a result of the calculation.

Another example (e.g., example 10) relates to a previously described example (e.g., example 9) or to any of the examples described herein, further comprising that the plurality of machine-readable instructions comprise instructions for calculating microservice-specific transformation functions or group-of-microservices-specific transformation functions based on the third portion of the telemetry information.

Another example (e.g., example 11) relates to a previously described example (e.g., one of the examples 9 to 10) or to any of the examples described herein, further comprising that the third portion of the telemetry information comprises a plurality of sets of telemetry data, wherein the plurality of machine-readable instructions comprise instructions for calculating a plurality of set-of-telemetry-data-specific transformation functions based on the third portion of the telemetry information.

Another example (e.g., example 12) relates to a previously described example (e.g., one of the examples 9 to 11) or to any of the examples described herein, further comprising that at least a first subset of the one or more transformation functions comprises at least one of a rounding component, a classification component, an averaging component, and a component for determining a mean.

Another example (e.g., example 13) relates to a previously described example (e.g., one of the examples 9 to 12) or to any of the examples described herein, further comprising that the plurality of machine-readable instructions comprise instructions for calculating at least a second subset of the one or more transformation functions further based on a numeric input provided by a microservice requesting the result of the respective transformation function.

Another example (e.g., example 14) relates to a previously described example (e.g., example 13) or to any of the examples described herein, further comprising that at least the second subset of the one or more transformation functions comprises at least one of a comparison component and a Boolean algebra component.

Another example (e.g., example 15) relates to a previously described example (e.g., one of the examples 1 to 14) or to any of the examples described herein, further comprising that the plurality of machine-readable instructions comprise instructions for evaluating the telemetry information based on a set of rules on a scaling of the plurality of microservices, and instructions for scaling up or scaling down the plurality of microservices based on the evaluation.

Another example (e.g., example 16) relates to a previously described example (e.g., one of the examples 1 to 15) or to any of the examples described herein, further comprising that the telemetry information comprises information on one or more of a load of the respective microservice, a rate of hardware utilization by the respective microservice, a rate of central processing unit (CPU) utilization by the respective microservice, a rate of graphics processing unit (GPU) utilization by the respective microservice, a rate of accelerator hardware utilization by the respective microservice, a rate of memory utilization by the respective microservice, a rate of network utilization by the respective microservice, a throughput of the microservice, a cache depth of the respective microservice and a latency of using the respective microservice.

An example (e.g., example 17) relates to a microservice apparatus (20) comprising interface circuitry (22), machine-readable instructions and processing circuitry (24) to execute the machine-readable instructions to provide telemetry information of a first microservice associated with the microservice apparatus to a telemetry hub (10), and to provide information on an access scheme for gaining access to the telemetry information of the first microservice to the telemetry hub.

Another example (e.g., example 18) relates to a previously described example (e.g., example 17) or to any of the examples described herein, further comprising that the plurality of machine-readable instructions comprise instructions for obtaining second telemetry information of a second microservice from the telemetry hub.

Another example (e.g., example 19) relates to a previously described example (e.g., example 18) or to any of the examples described herein, further comprising that the plurality of machine-readable instructions comprise instructions for decrypting the second telemetry information based on a microservice-specific cryptographic key or based on a group-of-microservices-specific cryptographic key.

Another example (e.g., example 20) relates to a previously described example (e.g., example 18) or to any of the examples described herein, further comprising that the plurality of machine-readable instructions comprise instructions for requesting the second telemetry information from the telemetry hub, with the request comprising a cryptographic signature being based on microservice-specific cryptographic key or based on a group-of-microservices-specific cryptographic key.

Another example (e.g., example 21) relates to a previously described example (e.g., one of the examples 18 to 20) or to any of the examples described herein, further comprising that the second telemetry information comprises derived telemetry information that is calculated based on a transformation function.

Another example (e.g., example 22) relates to a previously described example (e.g., example 21) or to any of the examples described herein, further comprising that the plurality of machine-readable instructions comprise instructions for providing a numeric input to the transformation function to the telemetry hub.

An example (e.g., example 23) relates to a computer system comprising the telemetry hub apparatus according to one of the examples 1 to 16 and one or more microservice apparatuses according to one of the examples 17 to 22.

An example (e.g., example 24) relates to a telemetry hub apparatus (10) comprising interface circuitry (12) and processing circuitry (14), the processing circuitry being configured to obtain telemetry information from a plurality of microservices (200). The processing circuitry is configured to provide access to the telemetry information for the plurality of microservices according to an access scheme.

Another example (e.g., example 25) relates to a previously described example (e.g., example 24) or to any of the examples described herein, further comprising that the processing circuitry is configured to limit access to the telemetry information according to the access scheme, with the access scheme being defined by the respective microservice providing the telemetry information.

Another example (e.g., example 26) relates to a previously described example (e.g., one of the examples 24 to 25) or to any of the examples described herein, further comprising that the access scheme defines access to the telemetry information based on a per-microservice or per-group-of-microservices granularity.

Another example (e.g., example 27) relates to a previously described example (e.g., example 26) or to any of the examples described herein, further comprising that the processing circuitry is configured to encrypt at least a first portion of the telemetry information with a per-microservice or per-group-of-microservices granularity, with the encryption limiting the access to the telemetry information based on the per-microservice or per-group-of-microservices granularity.

Another example (e.g., example 28) relates to a previously described example (e.g., example 27) or to any of the examples described herein, further comprising that the encryption is based on a public key associated with the respective microservice or group of microservices.

Another example (e.g., example 29) relates to a previously described example (e.g., example 26) or to any of the examples described herein, further comprising that the processing circuitry is configured to provide access to at least the first portion of the telemetry information in response to a microservice-specific or group-of-microservices-specific cryptographic signature provided by the respective microservice.

Another example (e.g., example 30) relates to a previously described example (e.g., example 29) or to any of the examples described herein, further comprising that the processing circuitry is configured to verify the cryptographic signature based on a public key associated with the respective microservice or group of microservices

Another example (e.g., example 31) relates to a previously described example (e.g., one of the examples 29 to 30) or to any of the examples described herein, further comprising that the processing circuitry is configured to provide unconstrained access to a second portion of the telemetry information.

Another example (e.g., example 32) relates to a previously described example (e.g., one of the examples 24 to 31) or to any of the examples described herein, further comprising that the processing circuitry is configured to calculate one or more transformation functions based on a third portion of the telemetry information, and to provide access to a derived version of the third portion of the telemetry information by providing a result of the calculation.

Another example (e.g., example 33) relates to a previously described example (e.g., example 32) or to any of the examples described herein, further comprising that the processing circuitry is configured to calculate microservice-specific transformation functions or group-of-microservices-specific transformation functions based on the third portion of the telemetry information.

Another example (e.g., example 34) relates to a previously described example (e.g., one of the examples 32 to 33) or to any of the examples described herein, further comprising that the third portion of the telemetry information comprises a plurality of sets of telemetry data, wherein the processing circuitry is configured to calculate a plurality of set-of-telemetry-data-specific transformation functions based on the third portion of the telemetry information.

Another example (e.g., example 35) relates to a previously described example (e.g., one of the examples 32 to 34) or to any of the examples described herein, further comprising that at least a first subset of the one or more transformation functions comprises at least one of a rounding component, a classification component, an averaging component, and a component for determining a mean.

Another example (e.g., example 36) relates to a previously described example (e.g., one of the examples 32 to 35) or to any of the examples described herein, further comprising that the processing circuitry is configured to calculate at least a second subset of the one or more transformation functions further based on a numeric input provided by a microservice requesting the result of the respective transformation function.

Another example (e.g., example 37) relates to a previously described example (e.g., example 36) or to any of the examples described herein, further comprising that at least the second subset of the one or more transformation functions comprises at least one of a comparison component and a Boolean algebra component.

Another example (e.g., example 38) relates to a previously described example (e.g., one of the examples 24 to 37) or to any of the examples described herein, further comprising that the processing circuitry is configured to evaluate the telemetry information based on a set of rules on a scaling of the plurality of microservices, and to scale up or scale down the plurality of microservices based on the evaluation.

Another example (e.g., example 39) relates to a previously described example (e.g., one of the examples 24 to 38) or to any of the examples described herein, further comprising that the telemetry information comprises information on one or more of a load of the respective microservice, a rate of hardware utilization by the respective microservice, a rate of central processing unit (CPU) utilization by the respective microservice, a rate of graphics processing unit (GPU) utilization by the respective microservice, a rate of accelerator hardware utilization by the respective microservice, a rate of memory utilization by the respective microservice, a rate of network utilization by the respective microservice, a throughput of the microservice, a cache depth of the respective microservice and a latency of using the respective microservice.

An example (e.g., example 40) relates to a microservice apparatus (20) comprising interface circuitry (22) and processing circuitry (24), the processing circuitry being configured to provide telemetry information of a first microservice associated with the microservice apparatus to a telemetry hub (10). The processing circuitry is configured to provide information on an access scheme for gaining access to the telemetry information of the first microservice to the telemetry hub.

Another example (e.g., example 41) relates to a previously described example (e.g., example 40) or to any of the examples described herein, further comprising that the processing circuitry is configured to obtain second telemetry information of a second microservice from the telemetry hub.

Another example (e.g., example 42) relates to a previously described example (e.g., example 41) or to any of the examples described herein, further comprising that the processing circuitry is configured to decrypt the second telemetry information based on a microservice-specific cryptographic key or based on a group-of-microservices-specific cryptographic key.

Another example (e.g., example 43) relates to a previously described example (e.g., example 41) or to any of the examples described herein, further comprising that the processing circuitry is configured to request the second telemetry information from the telemetry hub, with the request comprising a cryptographic signature being based on microservice-specific cryptographic key or based on a group-of-microservices-specific cryptographic key.

Another example (e.g., example 44) relates to a previously described example (e.g., one of the examples 41 to 43) or to any of the examples described herein, further comprising that the second telemetry information comprises derived telemetry information that is calculated based on a transformation function.

Another example (e.g., example 45) relates to a previously described example (e.g., example 44) or to any of the examples described herein, further comprising that the processing circuitry is configured to provide a numeric input to the transformation function to the telemetry hub.

An example (e.g., example 46) relates to a computer system comprising the telemetry hub apparatus according to one of the examples 24 to 39 and one or more microservice apparatuses according to one of the examples 40 to 45.

An example (e.g., example 47) relates to a telemetry hub device (10) comprising means for communicating (12) and means for processing (14), the means for processing being configured to obtain telemetry information from a plurality of microservices (200). The means for processing is configured to provide access to the telemetry information for the plurality of microservices according to an access scheme.

Another example (e.g., example 48) relates to a previously described example (e.g., example 47) or to any of the examples described herein, further comprising that the means for processing is configured to limit access to the telemetry information according to the access scheme, with the access scheme being defined by the respective microservice providing the telemetry information.

Another example (e.g., example 49) relates to a previously described example (e.g., one of the examples 47 to 48) or to any of the examples described herein, further comprising that the access scheme defines access to the telemetry information based on a per-microservice or per-group-of-microservices granularity.

Another example (e.g., example 50) relates to a previously described example (e.g., example 49) or to any of the examples described herein, further comprising that the means for processing is configured to encrypt at least a first portion of the telemetry information with a per-microservice or per-group-of-microservices granularity, with the encryption limiting the access to the telemetry information based on the per-microservice or per-group-of-microservices granularity.

Another example (e.g., example 51) relates to a previously described example (e.g., example 50) or to any of the examples described herein, further comprising that the encryption is based on a public key associated with the respective microservice or group of microservices.

Another example (e.g., example 52) relates to a previously described example (e.g., example 49) or to any of the examples described herein, further comprising that the means for processing is configured to provide access to at least the first portion of the telemetry information in response to a microservice-specific or group-of-microservices-specific cryptographic signature provided by the respective microservice.

Another example (e.g., example 53) relates to a previously described example (e.g., example 52) or to any of the examples described herein, further comprising that the means for processing is configured to verify the cryptographic signature based on a public key associated with the respective microservice or group of microservices

Another example (e.g., example 54) relates to a previously described example (e.g., one of the examples 52 to 53) or to any of the examples described herein, further comprising that the means for processing is configured to provide unconstrained access to a second portion of the telemetry information.

Another example (e.g., example 55) relates to a previously described example (e.g., one of the examples 47 to 54) or to any of the examples described herein, further comprising that the means for processing is configured to calculate one or more transformation functions based on a third portion of the telemetry information, and to provide access to a derived version of the third portion of the telemetry information by providing a result of the calculation.

Another example (e.g., example 56) relates to a previously described example (e.g., example 55) or to any of the examples described herein, further comprising that the means for processing is configured to calculate microservice-specific transformation functions or group-of-microservices-specific transformation functions based on the third portion of the telemetry information.

Another example (e.g., example 57) relates to a previously described example (e.g., one of the examples 55 to 56) or to any of the examples described herein, further comprising that the third portion of the telemetry information comprises a plurality of sets of telemetry data, wherein the means for processing is configured to calculate a plurality of set-of-telemetry-data-specific transformation functions based on the third portion of the telemetry information.

Another example (e.g., example 58) relates to a previously described example (e.g., one of the examples 55 to 57) or to any of the examples described herein, further comprising that at least a first subset of the one or more transformation functions comprises at least one of a rounding component, a classification component, an averaging component, and a component for determining a mean.

Another example (e.g., example 59) relates to a previously described example (e.g., one of the examples 55 to 58) or to any of the examples described herein, further comprising that the means for processing is configured to calculate at least a second subset of the one or more transformation functions further based on a numeric input provided by a microservice requesting the result of the respective transformation function.

Another example (e.g., example 60) relates to a previously described example (e.g., example 59) or to any of the examples described herein, further comprising that at least the second subset of the one or more transformation functions comprises at least one of a comparison component and a Boolean algebra component.

Another example (e.g., example 61) relates to a previously described example (e.g., one of the examples 47 to 60) or to any of the examples described herein, further comprising that the means for processing is configured to evaluate the telemetry information based on a set of rules on a scaling of the plurality of microservices, and to scale up or scale down the plurality of microservices based on the evaluation.

Another example (e.g., example 62) relates to a previously described example (e.g., one of the examples 47 to 61) or to any of the examples described herein, further comprising that the telemetry information comprises information on one or more of a load of the respective microservice, a rate of hardware utilization by the respective microservice, a rate of central processing unit (CPU) utilization by the respective microservice, a rate of graphics processing unit (GPU) utilization by the respective microservice, a rate of accelerator hardware utilization by the respective microservice, a rate of memory utilization by the respective microservice, a rate of network utilization by the respective microservice, a throughput of the microservice, a cache depth of the respective microservice and a latency of using the respective microservice.

An example (e.g., example 63) relates to a microservice device (20) comprising means for communicating (22) and means for processing (24), the means for processing being configured to provide telemetry information of a first microservice associated with the microservice device to a telemetry hub (10). The means for processing is configured to provide information on an access scheme for gaining access to the telemetry information of the first microservice to the telemetry hub.

Another example (e.g., example 64) relates to a previously described example (e.g., example 63) or to any of the examples described herein, further comprising that the means for processing is configured to obtain second telemetry information of a second microservice from the telemetry hub.

Another example (e.g., example 65) relates to a previously described example (e.g., example 64) or to any of the examples described herein, further comprising that the means for processing is configured to decrypt the second telemetry information based on a microservice-specific cryptographic key or based on a group-of-microservices-specific cryptographic key.

Another example (e.g., example 66) relates to a previously described example (e.g., example 64) or to any of the examples described herein, further comprising that the means for processing is configured to request the second telemetry information from the telemetry hub, with the request comprising a cryptographic signature being based on microservice-specific cryptographic key or based on a group-of-microservices-specific cryptographic key.

Another example (e.g., example 67) relates to a previously described example (e.g., one of the examples 64 to 66) or to any of the examples described herein, further comprising that the second telemetry information comprises derived telemetry information that is calculated based on a transformation function.

Another example (e.g., example 68) relates to a previously described example (e.g., example 67) or to any of the examples described herein, further comprising that the means for processing is configured to provide a numeric input to the transformation function to the telemetry hub.

An example (e.g., example 69) relates to a computer system comprising the telemetry hub device according to one of the examples 47 to 62 and one or more microservice devices according to one of the examples 63 to 68.

An example (e.g., example 70) relates to a telemetry hub method comprising obtaining (110) telemetry information from a plurality of microservices. The telemetry hub method comprises providing (120) access to the telemetry information for the plurality of microservices according to an access scheme.

Another example (e.g., example 71) relates to a previously described example (e.g., example 70) or to any of the examples described herein, further comprising that the telemetry hub method comprises (130) limiting access to the telemetry information according to the access scheme, with the access scheme being defined by the respective microservice providing the telemetry information.

Another example (e.g., example 72) relates to a previously described example (e.g., one of the examples 70 to 71) or to any of the examples described herein, further comprising that the access scheme defines access to the telemetry information based on a per-microservice or per-group-of-microservices granularity.

Another example (e.g., example 73) relates to a previously described example (e.g., example 72) or to any of the examples described herein, further comprising that the telemetry hub method comprises encrypting (132) at least a first portion of the telemetry information with a per-microservice or per-group-of-microservices granularity, with the encryption limiting the access to the telemetry information based on the per-microservice or per-group-of-microservices granularity.

Another example (e.g., example 74) relates to a previously described example (e.g., example 73) or to any of the examples described herein, further comprising that the encryption is based on a public key associated with the respective microservice or group of microservices.

Another example (e.g., example 75) relates to a previously described example (e.g., example 72) or to any of the examples described herein, further comprising that the telemetry hub method comprises providing (134) access to at least the first portion of the telemetry information in response to a microservice-specific or group-of-microservices-specific cryptographic signature provided by the respective microservice.

Another example (e.g., example 76) relates to a previously described example (e.g., example 75) or to any of the examples described herein, further comprising that the telemetry hub method comprises verifying the cryptographic signature based on a public key associated with the respective microservice or group of microservices.

Another example (e.g., example 77) relates to a previously described example (e.g., one of the examples 75 to 76) or to any of the examples described herein, further comprising that the telemetry hub method comprises providing (140) unconstrained access to a second portion of the telemetry information.

Another example (e.g., example 78) relates to a previously described example (e.g., one of the examples 70 to 77) or to any of the examples described herein, further comprising that the telemetry hub method comprises calculating (150) one or more transformation functions based on a third portion of the telemetry information and providing (155) access to a derived version of the third portion of the telemetry information by providing a result of the calculation.

Another example (e.g., example 79) relates to a previously described example (e.g., example 78) or to any of the examples described herein, further comprising that the telemetry hub method comprises calculating (150) microservice-specific transformation functions or group-of-microservices-specific transformation functions based on the third portion of the telemetry information.

Another example (e.g., example 80) relates to a previously described example (e.g., one of the examples 78 to 79) or to any of the examples described herein, further comprising that the third portion of the telemetry information comprises a plurality of sets of telemetry data, wherein the telemetry hub method comprises calculating (150) a plurality of set-of-telemetry-data-specific transformation functions based on the third portion of the telemetry information.

Another example (e.g., example 81) relates to a previously described example (e.g., one of the examples 78 to 80) or to any of the examples described herein, further comprising that at least a first subset of the one or more transformation functions comprises at least one of a rounding component, a classification component, an averaging component, and a component for determining a mean.

Another example (e.g., example 82) relates to a previously described example (e.g., one of the examples 78 to 81) or to any of the examples described herein, further comprising that the telemetry hub method comprises calculating (150) at least a second subset of the one or more transformation functions further based on a numeric input provided by a microservice requesting the result of the respective transformation function.

Another example (e.g., example 83) relates to a previously described example (e.g., example 82) or to any of the examples described herein, further comprising that at least the second subset of the one or more transformation functions comprises at least one of a comparison component and a Boolean algebra component.

Another example (e.g., example 84) relates to a previously described example (e.g., one of the examples 70 to 83) or to any of the examples described herein, further comprising that the telemetry hub method comprises evaluating (160) the telemetry information based on a set of rules on a scaling of the plurality of microservices, and scaling (165) up or scaling down the plurality of microservices based on the evaluation.

Another example (e.g., example 85) relates to a previously described example (e.g., one of the examples 70 to 84) or to any of the examples described herein, further comprising that the telemetry information comprises information on one or more of a load of the respective microservice, a rate of hardware utilization by the respective microservice, a rate of central processing unit (CPU) utilization by the respective microservice, a rate of graphics processing unit (GPU) utilization by the respective microservice, a rate of accelerator hardware utilization by the respective microservice, a rate of memory utilization by the respective microservice, a rate of network utilization by the respective microservice, a throughput of the microservice, a cache depth of the respective microservice and a latency of using the respective microservice.

An example (e.g., example 86) relates to a microservice method comprising providing (210) telemetry information of a first microservice performing the microservice method to a telemetry hub. The microservice method comprises providing (215) information on an access scheme for gaining access to the telemetry information of the first microservice to the telemetry hub.

Another example (e.g., example 87) relates to a previously described example (e.g., example 86) or to any of the examples described herein, further comprising that the microservice method comprises obtaining (230) second telemetry information of a second microservice from the telemetry hub.

Another example (e.g., example 88) relates to a previously described example (e.g., example 87) or to any of the examples described herein, further comprising that the microservice method comprises decrypting (235) the second telemetry information based on a microservice-specific cryptographic key or based on a group-of-microservices-specific cryptographic key.

Another example (e.g., example 89) relates to a previously described example (e.g., example 87) or to any of the examples described herein, further comprising that the microservice method comprises requesting (220) the second telemetry information from the telemetry hub, with the request comprising a cryptographic signature being based on microservice-specific cryptographic key or based on a group-of-microservices-specific cryptographic key.

Another example (e.g., example 90) relates to a previously described example (e.g., one of the examples 87 to 89) or to any of the examples described herein, further comprising that the second telemetry information comprises derived telemetry information that is calculated based on a transformation function.

Another example (e.g., example 91) relates to a previously described example (e.g., example 90) or to any of the examples described herein, further comprising that the microservice method comprises providing (225) a numeric input to the transformation function to the telemetry hub.

An example (e.g., example 92) relates to a computer system comprising one or more microservices being configured to perform the method according to one of the examples 86 to 91, the computer system being configured to perform the method according to one of the examples 70 to 85.

An example (e.g., example 93) relates to a non-transitory machine-readable storage medium including program code, when executed, to cause a machine to perform the method of one of the examples 70 to 85 or the method of one of the examples 86 to 91.

An example (e.g., example 94) relates to a computer program having a program code for performing the method of one of the examples 70 to 85 or the method of one of the examples 86 to 91 when the computer program is executed on a computer, a processor, or a programmable hardware component.

An example (e.g., example 95) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A telemetry hub apparatus comprising interface circuitry, machine-readable instructions and processing circuitry to execute the machine-readable instructions to:
obtain telemetry information from a plurality of microservices; and
provide access to the telemetry information for the plurality of microservices according to an access scheme.

2. The telemetry hub apparatus according to claim 1, wherein the plurality of machine-readable instructions comprise instructions for limiting access to the telemetry information according to the access scheme, with the access scheme being defined by the respective microservice providing the telemetry information.

3. The telemetry hub apparatus according to claim 1, wherein the access scheme defines access to the telemetry information based on a per-microservice or per-group-of-microservices granularity.

4. The telemetry hub apparatus according to claim 3, wherein the plurality of machine-readable instructions comprise instructions for encrypting at least a first portion of the telemetry information with a per-microservice or per-group-of-microservices granularity, with the encryption limiting the access to the telemetry information based on the per-microservice or per-group-of-microservices granularity.

5. The telemetry hub apparatus according to claim 4, wherein the encryption is based on a public key associated with the respective microservice or group of microservices.

6. The telemetry hub apparatus according to claim 3, wherein the plurality of machine-readable instructions comprise instructions for providing access to at least the first portion of the telemetry information in response to a microservice-specific or group-of-microservices-specific cryptographic signature provided by the respective microservice.

7. The telemetry hub apparatus according to claim 6, wherein the plurality of machine-readable instructions comprise instructions for verifying the cryptographic signature based on a public key associated with the respective microservice or group of microservices

8. The telemetry hub apparatus according to claim 6, wherein the plurality of machine-readable instructions comprise instructions for providing unconstrained access to a second portion of the telemetry information.

9. The telemetry hub apparatus according to claim 1, wherein the plurality of machine-readable instructions comprise instructions for calculating one or more transformation functions based on a third portion of the telemetry information, and instructions for providing access to a derived version of the third portion of the telemetry information by providing a result of the calculation.

10. The telemetry hub apparatus according to claim 9, wherein the plurality of machine-readable instructions comprise instructions for calculating microservice-specific transformation functions or group-of-microservices-specific transformation functions based on the third portion of the telemetry information.

11. The telemetry hub apparatus according to claim 9, wherein the third portion of the telemetry information comprises a plurality of sets of telemetry data, wherein the plurality of machine-readable instructions comprise instructions for calculating a plurality of set-of-telemetry-data-specific transformation functions based on the third portion of the telemetry information.

12. The telemetry hub apparatus according to claim 9, wherein the plurality of machine-readable instructions comprise instructions for calculating at least a second subset of the one or more transformation functions further based on a numeric input provided by a microservice requesting the result of the respective transformation function.

13. The telemetry hub apparatus according to claim 1, wherein the plurality of machine-readable instructions comprise instructions for evaluating the telemetry information based on a set of rules on a scaling of the plurality of microservices, and instructions for scaling up or scaling down the plurality of microservices based on the evaluation.

14. The telemetry hub apparatus according to claim 1, wherein the telemetry information comprises information on one or more of a load of the respective microservice, a rate of hardware utilization by the respective microservice, a rate of central processing unit (CPU) utilization by the respective microservice, a rate of graphics processing unit (GPU) utilization by the respective microservice, a rate of accelerator hardware utilization by the respective microservice, a rate of memory utilization by the respective microservice, a rate of network utilization by the respective microservice, a throughput of the microservice, a cache depth of the respective microservice and a latency of using the respective microservice.

15. A microservice apparatus comprising interface circuitry, machine-readable instructions and processing circuitry to execute the machine-readable instructions to:
provide telemetry information of a first microservice associated with the microservice apparatus to a telemetry hub; and
provide information on an access scheme for gaining access to the telemetry information of the first microservice to the telemetry hub.

16. The microservice apparatus according to claim 15, wherein the plurality of machine-readable instructions comprise instructions for obtaining second telemetry information of a second microservice from the telemetry hub.

17. The microservice apparatus according to claim 16, wherein the plurality of machine-readable instructions comprise instructions for decrypting the second telemetry information based on a microservice-specific cryptographic key or based on a group-of-microservices-specific cryptographic key.

18. The microservice apparatus according to claim 16, wherein the plurality of machine-readable instructions comprise instructions for requesting the second telemetry information from the telemetry hub, with the request comprising a cryptographic signature being based on microservice-specific cryptographic key or based on a group-of-microservices-specific cryptographic key.

19. The microservice apparatus according to claim 16, wherein the second telemetry information comprises derived telemetry information that is calculated based on a transformation function.

20. The microservice apparatus according to claim 19, wherein the plurality of machine-readable instructions comprise instructions for providing a numeric input to the transformation function to the telemetry hub.

21. A computer system comprising the telemetry hub apparatus according to claim 1 and one or more microservice apparatuses according to claim 15.

22. A telemetry hub method comprising:
obtaining telemetry information from a plurality of microservices; and
providing access to the telemetry information for the plurality of microservices according to an access scheme.

23. A non-transitory machine-readable storage medium including program code, when executed, to cause a machine to perform the method of claim 22.

24. A microservice method comprising:
providing telemetry information of a first microservice performing the microservice method to a telemetry hub; and
providing information on an access scheme for gaining access to the telemetry information of the first microservice to the telemetry hub.

25. A non-transitory machine-readable storage medium including program code, when executed, to cause a machine to perform the method of claim 24.
